(19) United States
(12) Patent Application Publication
(10) Pub. No.: US 2004/0048536 A1
(43) Pub. Date: Mar. 11, 2004

(54) Stab resistant article

(75) Inventors: Kaj Granqvist, Taby (SE); Anders Ortegren, Uppsala (SE); Gerry Castenback, Bromma (SE)

Correspondence Address: YOUNG & THOMPSON, 745 SOUTH 23RD STREET 2ND FLOOR, ARLINGTON, VA, 22202

(73) Assignee: SAFEBOARD AB, STOCKHOLM (SE)

(21) Appl. No.: 10/234,476

(22) Filed: Sep. 5, 2002

(51) Int. Cl. B32B 27/04

(52) U.S. Cl. 442/134

(57) ABSTRACT

The invention relates to a stab resistant article consisting essentially of one or more layers of a fabric with a tensile strength larger than 50N/5 cm having been treated with a composition comprising 0.1-2 mm particles of inorganic oxides and powder of inorganic oxides having a true density of 1000-4000 kg/m³ and a curable plastic material chosen from polyvinyl chloride, polyurethanes or acrylates.

It also relates to penetration resistant articles comprising an inner ballistic resistant means and an outer stab resistant means and an ice pick resistant article between said inner ballistic resistant means and said outer stab resistant means. It also relates to a method for protection of an article or a body against penetration articles.

The present invention relates to stab resistant articles, which protect from penetration, such as stabs or thrusts from sharp instruments. It also relates to penetration resistant articles comprising an inner ballistic resistant means and an outer stab resistant means and an ice pick article between said inner ballistic resistant means and said outer stab resistant means. It also relates to a method for protection of an article or a body against penetration articles.

### TECHNICAL BACKGROUND

There has long been a need for protective garments exhibiting improved penetration resistance from sharp pointed implements. However, attention has been directed primarily toward ballistics and toward garments, which provide protection from ballistics threats.

International Publication WO 93/00564, published Jan. 7, 1993 discloses ballistic structures using layers of fabric woven from high tenacity para-aramid yarn.

Attempts have been made to provide both puncture resistance and ballistic resistance. Thus, U.S. Pat. No. 5,472,769 describes a combination of knitted aramid yarn layers and deflection layers of materials such as metal wire. European Patent No. 670,466 describes a ballistic and stab-resistant system wherein the stab resistance is imparted by embedding chainmail in a polymer resin.

Structures for protection from both ice pick and stab penetration and ballistic threats are disclosed in U.S. Pat. No. 6,133,169. They are composed of flexible metallic based structures, tightly-woven fabric layers, and ballistic layers, all arranged such that the tightly-woven fabrics layers are nearer than the ballistic layers to the threat strike face of the structure.

In U.S. Pat. No. 5,677,029 a flexible article is described, which comprises two or more layers, at least one of said layers being a fibrous layer, and at least one of said layers being a polymeric layer in contact with and bound to all or portion of said fibrous layer. It is especially ballistic resistant but also penetration resistant to both ice pick and stab.

The present invention relates to a stab resistant article and garments and articles comprising the stab resistant article outside an inner ballistic protection means and an intervening ice pick protection means.

### SUMMARY OF THE INVENTION

The present invention relates to a stab resistant article consisting essentially of one or more layers of a fabric with a tensile strength larger than 50N/5 cm having been treated with a coating comprising 0.1-2 mm particles of inorganic oxides and powder of inorganic oxides having a true density of 1000-4000 kg/m³ and a curable material chosen from polyvinyl chloride, polyurethanes, acrylates or silicones.

The articles according to the invention are advantageous in that they are specially designed for protection against stabs, knives and sharp articles and are very flexible. They are not as heavy as previously known protective garments resistant to sharp articles and can be inserted in one or more layers into protective vests while maintaining that flexibility. They are low in cost. Moreover, the articles are not sensitive to UV light in that they keep their characteristics unaffected. The article according to the invention may be used as a stab resistant means together with a ballistic resistant layer and ice pick resistant article. Preferably the article is placed on the outside of an inner ballistic resistant layer and an intervening ice pick resistant article.

### DETAILED DESCRIPTION OF THE INVENTION

The invention relates to a stab resistant article consisting essentially of one or more layers of a fabric with a tensile strength larger than 50N/5 cm having been treated with a coating comprising 0.1-2 mm particles of inorganic oxides and powder of inorganic oxides having a true density of 1000-4000 kg/m³, preferably 2000-3000 kg/m³ and a curable material chosen from polyvinyl chloride, polyurethanes, acrylates or silicones.

The fabric for use according to the invention is not critical, the important thing being the composition for treatment of the fabric. I may be a woven, non-woven or a tricot and may be made from any synthetic, natural or glass fiber or derivatives or mixtures thereof. Preferred materials in the yarn in a woven or tricot fabric or in the non-woven are polyester, polyamide, polypropylene, polyethylene, cotton or derivatives or mixtures thereof.

The yarn of the fabric that is used in the article according to the invention may be produced from the following compounds.

Aliphatic, cycloaliphatic and aromatic polyesters may be used such as poly(1,4-cyclohexlidene dimethyl eneterephathalate) cis and trans, poly(ethylene-1,5-naphthalate), poly(ethylene-2,6-naphthalate), poly(1,4-cyclohexane dimethylene terephthalate) (trans), poly(decamethylene terephthalate), poly(ethylene terephthalate), poly(ethylene isophthalate), poly(ethylene oxybenozoate), poly(para-hydroxy benzoate), poly(dimethylpropiolactone), poly(decamethylene adipate), poly(ethylene succinate), poly(ethylene azelate), poly(decamethylene sebacate), poly(β,β-dimethyl-propiolactone), and the like.

Polyesters may be used according to the invention, such as those of the compositions include poly(oxy-trans-1,4-cyclohexyleneoxycarbonyl-trans-1,4-cyclohexylenecarbony 1-β-oxy-1,4-phenyl-eneoxyterephthaloyl) and poly(oxy-cis-1,4-cyclohexyleneoxycarbonyl-trans-1,4-cyclohexylenecarbonyl-β-oxy-1,4-phenyleneoxyterephthaloyl) in methylene chloride-o-cresol poly[(oxy-trans-1,4-cyclohexylene-oxycarbonyl-trans-1,4-cyclohexylenecarbonyl-β-oxy-(2-methyl-1,4-phenylene)oxy-terephthaloyl)] in 1,1,2,2-tetrachloroethane-o-chlorophenol-phenol (60:25:15 vol/vol/vol), poly[oxy-trans-1,4-cyclohexyleneoxycarbonyl-trans-1,4-cyclohexylenecarbony 1-β-oxy(2-methyl-1,3-phenylene)oxy-terephthaloyl] in o-chlorophenol and the like;

Thermotropic copolyesters may also be used as for example copolymers of 6-hydroxy-2-naphthoic acid and p-hydroxy benzoic acid, copolymers of 6-hydroxy-2-naphthoic acid, terephthalic acid and p-amino phenol, copolymers of 6-hydroxy-2-naphthoic acid, terephthalic acid and hydroquinone, copolymers of 6-hydoroxy-2-naphtoic acid, p-hydroxy benzoic acid, hydroquinone and terephthalic acid, copolymers of 2,6-naphthalene dicarboxylic acid, terephthalic acid, isophthalic acid and hydroquinone, copolymers of 2,6-naphthalene dicarboxylic acid and terephthalic acid, copolymers of p-hydroxybenzoic acid, terephthalic acid and 4,4′-dihydoxydiphenyl, copolymers of p-hydroxybenzoic acid, terephthalic acid, isophthalic acid and 4,4′-dihydroxydiphenyl, p-hydroxybenzoic acid, isophthalic acid, hydroquinone and 4,4′-dihydroxybenzophenone, copolymers of phenylterephthalic acid and hydroquinone, copolymers of chlorohydroquinone, terephthalic acid and p-acetoxy cinnamic acid, copolymers of chlorohydroquinone, terephthalic acid and ethylene dioxy-4,4′-dibenzoic acid, copolymers of hydroquinone, methylhydroquinone, p-hydroxybenzoic acid and isophthalic acid, copolymers of (1-phenylethyl)hydroquinone, terephthalic acid and hydroquinone, and copolymers of poly(ethylene terephthalate) and p-hydroxybenzoic acid; and thermotropic polyamides and thermotropic copoly(amide-esters).

Other suitable polyesters may be poly(ethylene azelate), poly(ethylene-1,5-naphthalate), poly(1,4-cyclohexane dimethylene terephthalate), poly(ethylene oxybenzoate) (A-Tell), poly(para-hydroxy benzoate) (Ekonol), poly(1,4-cyclohexylidene dimethylene terephthalate) (Kodel)(as), poly(1,4-cyclohexylidene dimethylene terephthalate) (Kodel) (trans), polyethylene terephthalate, polybutylene terephthalate and the like.

Aliphatic and cycloaliphatic polyamides may also be used according to the invention, such as the copolyamide of 30% hexamethylene diammonium isophthalate and 70% hexamethylene diammonium adipate, the copolyamide of up to 30% bis-(-amidocyclohexyl)methylene, terephthalic acid and caprolactam, polyhexamethylene adipamide (polyamide 66), poly(butyrolactam) (polyamide 4), poly (9-aminonoanoic acid), polyamide 46 poly(tetra-methylene-adipaide), (polyamide 9), poly(enantholactam) (polyamide7), poly(capryllactam) (polyamide 8), polycaprolactam (polyamide 6), poly(p-phenylene terephthalamide), polyhexamethylene sebacamide (polyamide 6,10), polyaminoundecanamide (polyamide 11), polydodeconolactam (polyamide 12), polyhexamethylene isophthalamide, polyhexamethylene terephthalamide, polycaproamide, poly(nonamethylene azelamide) (polyamide 9,9), poly(decamethylene azelamide) (polyamide 10,9), poly(decamethylene sebacamide) (polyamid 10,10), poly>bis-(4-aminocyclothexyl)methane 1,10-decanedicarboxamide (Qiana) (trans), or combination thereof; polyamide 66 is preferred.

Fabrics of the present invention may be made from yarns of aramid fibres. By “aramid” is meant a polyamide wherein at least 85% of the amide (—CO—NH—) linkages are attached directly to two aromatic rings. Suitable aramid fibres are described in Man-Made Fibres-Science and Technology, Volume 2, Section titled Fibre-Forming Aromatic Polyamides, page 297, W. Black et al., Interscience Publishers, 1968. Aramid fibres are, also, disclosed in U.S. Pat. Nos. 4,172,938; 3,869,429; 3,819,587; 3,673,143; 3,354,127, and 3,094,511.

Illustrative of other useful aramids are poly(m-xylylene adipamide), poly(p-xylylene sebacamide), poly 2,2,2-trimethylhexamethylene terephthalamide), poly(piperazine sebacamide), poly(metaphenylene isophthalamide) (Nomex.RTM.) and poly(p-phenylene terephthalamide) (Kevlar.RTM.); poly(1,4-benzamide), poly(chloro-1,4-phenylene terephthalamide), poly(1,4-phenylene fumaramide), poly(chloro-1,4-phenylene fumaramide), poly(4,4′-benzanilide trans, transmuconamide), poly(1,4-phenylene mesaconamide), poly(1,4-phenylene) (trans-1,4-cyclohexylene amide), poly(chloro-1,4-phenylene) (trans-1,4-cyclohexylene amide), poly(1,4-phenylene 1,4-dimethyl-trans-1,4-cyclohexylene amide), poly(1,4-phenylene 2.5-pyridine amide), poly(chloro-1,4-phenylene 2.5-pyridine amide), poly(3,3′-dimethyl-4,4′-biphenylene 2.5 pyridine amide), poly(1,4-phenylene 4,4′-stilbene amide), poly(chloro-1,4-phenylene 4,4′-stilbene amide), poly(1,4-phenylene 4,4′-azobenzene amide), poly(4,4′-azobenzene 4,4′-azobenzene amide), poly(1,4′-phenylene 4,4′-azoxybenzene amide), poly(4,4′-azobenzene 4,4′-azoxybenzene amide), poly(1,4-cyclohexylene 4,4′-azobenzene amide), poly(4,4′-azobenzene terephthal amide), poly(3.8-phenanthridinone terephthal amide), poly(4,4′-biphenylene terephthal amide), poly(4,4′-biphenylene 4,4′-bibenzo amide), poly(1,4-phenylene 4,4′-bibenzo amide), poly(1,4-phenylene 4,4′-terephenylene amide), poly(1,4-phenylene 2,6-naphthal amide), poly(1,5-naphthylene terephthal amide), poly(3,3′-dimethyl-4,4-biphenylene terephthal amide), poly(3,3′-dimethoxy-4,4′-biphenylene terephthal amide), poly(3,3′-dimethoxy-4,4-biphenylene 4,4′-bibenzo amide) and the like; polyoxamides such as those derived from 2,2′dimethyl-4,4′diamino biphenyl and chloro-1,4-phenylene diamine; polyhydrazides such as poly chloroterephthalic hydrazide, 2,5-pyridine dicarboxylic acid hydrazide) poly(terephthalic hydrazide), poly(terephthalic-chloroterephthalic hydrazide) and the like; poly(amide-hydrazides) such as poly(terephthaloyl 1,4 amino-benzhydrazide) and those prepared from 4-amino-benzhydrazide, oxalic dihydrazide, terephthalic dihydrazide and para-aromatic diacid chlorides;

In the case of polyethylene, suitable fibres are those of molecular weight of at least 150,000, especially at least 500,000, preferably at least one million and more preferably between two million and five million. Such extended chain polyethylene (ECPE) fibres may be grown in solution as described in U.S. Pat. No. 4,137,394 to Meihuzen et al., or U.S. Pat. No. 4,356,138 of Kavesh et al., issued Oct. 26, 1982, or a filament spun from a solution to form a gel structure, as described in German Off. 3,004,699 and GB 2051667, and especially described in U.S. Ser. No. 572,607 of Kavesh et al., filed Jan. 20, 1984 (see EPA 64,167, published Nov. 10, 1982).

As used herein, the term polyethylene shall mean a predominantly linear polyethylene material that may contain minor amounts of chain branching or comonomers not exceeding 5 modifying units per 100 main chain carbon atoms, and that may also contain admixed therewith not more than about 50 wt % of one or more polymeric additives such as alkene-1-polymers, in particular low density polyethylene, polypropylene or polybutylene, copolymers containing mono-olefins as primary monomers, oxidised polyolefins, graft polyolefin copolymers and polyoxymethylenes, or low molecular weight additives such as anti-oxidants, lubricants, ultra-violet screening agents, colorants and the like which are commonly incorporated by reference. Depending upon the formation technique, the draw ratio and temperatures, and other conditions, a variety of properties can be imparted to these fibres.

Preferred polyethylene fibres are Dyneema produced by DSM High Performance Fibres BV Eisterweg 3 6422 PN Heerlen Netherlands, and Spectra, produced by Honeywell Honeywell Performance Fibres Pole European de Development B.P. 16 548 10 Longlaville France.

It is also possible to use mixtures of all material mentioned herein, especially the polyethylenes and the polyamides.

Highly oriented polypropylene fibres of molecular weight about at least 200,000, especially about at least 750,000, preferably at least one million and more preferably at least two million may also be used. Such high molecular weight polypropylene may be formed into reasonably well oriented fibres by the techniques prescribed in the various references referred to above, and especially by the technique of U.S. Ser. No. 572,607 and of U.S. Ser. No. 259,266, and the continuations-in-part thereof. Polypropylene is a much less crystalline material than polyethylene and contains pendant methyl groups.

Polyamide prepared from the reaction of hexamethylene diamine and adipic acid (polyamide 6,6) is the preferred material in the article according to the invention.

The linear density of a yarn is determined by weighing a known length of the yarn. “dTex” is defined as the weight, in grams, of 10,000 meters of the yarn. The linear density may be less than 1800 dTex, preferably 100 dTex-1800 dTex, especially 200 dTex-950 dTex,

The yarn has preferably 20-250 filaments in warp and weft. Examples of number of filaments used in warp and weft are 60-160, such as 72 in warp and weft. There may be different numbers or the same numbers of filaments in warp and weft, preferably the same number.

The closeness of the fabric is around 10-30 threads/cm in he warp and 10-30 threads/cm in the weft, e.g. 17 threads/cm in the warp and 17 threads/cm in the weft. The closeness may be different or the same in warp and weft, preferably the same.

It may be suitable to treat the fabric with a base coat containing an adhesion promoter. The adhesion promoter increases the adhesion between fabric and coating. Thus one may first treat the fabric with an adhesion promoter, which does not affect the fabric negatively and may be a polyisocyanate such as toluylen diisocyanate, methylene.bis.phenyl-diisocyanate, and its homologs and trimethylol-propyl-toluylen-diisocyanate and triphenylmethane-4,4′,4″-triisocyanate may be used. Preferably Haftvermittler VP SP 51004 is used.

One or more adhesion promoters may be used. The adhesion promoter may be mixed in a carrier or mixed with the curable flexible material that is used for applying the particles and powder of inorganic oxides and used as an adhesion promoter composition.

Thereafter a composition, preferably a paste comprising a curable material chosen from polyvinyl chloride, polyurethanes, acrylates or silicones and particles of inorganic oxides 0.1-2 mm, preferably 0.2-1 mm and powder of inorganic oxides having a true density of 1000-4000 kg/m³, preferably 2000-3000 kg/m³, is applied to the fabric.

The paste may be sprayed, coated, printed or in any other way applied to the fabric. The fabric may also be dipped into the paste. Preferably the paste is applied to one side of the fabric.

By curable we understand a material that is transferred to form a stable condition by polymerisation or cross linking e.g. by time, moisture, heat or light of suitable wavelength.

The curable polyurethanes are well known in the art and are readily commercially available. Various known polyols and polyisocyanates are used to form polyurethanes. Polyurethanes are described, for example, in Chapter X, Coatings, pp. 453-607 in J. H. Saunders and K. C. Frisch, Polyurethanes: Chemistry and Technology, Part II, Interscience Publishers (NY, 1964), incorporated herein by reference.

Suitable polyurethanes may be prepared in a conventional manner such as by reacting polyols or hydroxylated polymers with organic polyisocyanates in the manner well known in the art. Suitable organic polyisocyanates include, for instance, ethyl diisocyanate; ethylidene diisocyanate; propylene-1,2-diisocyanate; cyclohexylene-1,2-diisocyanate; m-phenylene diisocyanate; 2,4-toluene diisocyanate; 2,6-toluene diisocyanate; 3,3′-dimethyl-4,4′-biphenyl diisocyanate; p,p′,p″-triphenylmethane triisoene diisocyanate; 3,3′-diphenyl-4,4′-biphenylene diisocyanate; 4,4′-biphenylene diisocyanate; 3,3′-dichloro-4,4-biphenylene diisocyanate; p,p′,p″-triphenylmethane triisocyanate; 1,5-mepthalene diisocyanate; furfurylidene diisocyanate or polyisocyanates, in a blocked or inactive form such as bis-phenyl carbamates of 2,4- or 2,6-toluene diisocyanate; p,p″-diphenyl methane diisocyanate; p-phenylene diisocyanate; 1,5-napthalene diisocyanate and the like. It is preferred to use a commercially available mixture of toluene diisocyanates, which contains 80 percent 2,4-toluene diisocyanate and 20 percent 2,6-toluene diisocyanate or 4,4-diphenylmethane diisocyanate.

Polyurethanes applied as base coats in accordance with the invention may, of course, be in the form of solutions in suitable solvents such as xylene, toluene, methyl ethyl ketone, butanol, butyl acetate, etc.

Materials for the polyurethane base coats may be supplied in one package or two package prepolymer systems or oil modified systems, etc., all in the manner well known in the industry. Such materials are described for instance in the pamphlet “Urethane Coatings”, published by the Federation of Societies for Paint Technology (1970). Radiation-curable urethane coatings may also of course be used.

Some illustrative examples of suitable polyurethane compositions are disclosed in U.S. Pat. Nos. 4,699,814; 4,681,811; 4,703,101; 4,403,003 and 5,268,215, all of which are incorporated herein by reference.

Another suitable type of polyurethane is an acrylic polyurethane. The acrylic polyurethanes are described in U.S. Pat. Nos. 3,558,564, 4,131,571 and 4,555,535, all of which are incorporated herein by reference.

The acrylates may be chosen from n-propyl-, n.pentyl-, n-hexyl-, n-heptyl-, isopropyl-, sec.-butyl-, t.-butyl-, allyl-, 2-hydroxyethyl-, 2-hydroxypropyl-acrylate, ethylene-glycol-diester, 1,2-propanediol-diester and 1,4-butanediol-dister of acrylic acid.

The composition may also comprise plasticizers in order to facilitate the processing. Plasticizers which may be used, particularly in the case of PVC, are adipic esters (dioctyl adipate, diisononyl adipate, diisodecyl adipiate, dibutyl adipate, benzyloctyl adipate), phosphoric esters (tricresyl, triphenyl, diphenylsylenile, trichloroethyl), diphenyloctyl, trioctyl phosphates, tri-2-ethylhexyl-phosphate, 2-ethylhexyl-diphenyl-phosphate,), phthalic esters (dimethyl-, diethyl-, dibutyl-, diisobutyl-diisoheptyl-, L 79-, L711-, dioctyl-, diisooctyl-, dinonyl, diisononyl-, diisodecyl (DIDP), L911-diundecyl-, undecyl-dodecyl-, diisotridecyl-benzylbutyl, dicyclohexyl phthalates), sulfonic esters, chlorinated paraffins, trimellitates (trioctyl-trimellitate, L79-trimellitate and L810-trimellitate). With PVC powder, di(2-ethylhexyl)-phthalate (abbreviated to DOP) and bis(2ethylhexyl)-phthalate (abbreviated to DOP) and diisodecyl-phthalate (DIDP) will preferably be used (from MB-Sveda AB, MBS Nordic, Malmö, Sweden).

Other types of plasticizers useful according to this invention are mono-sulfonamides and bis-sulfonamides. The mono-sulfonamide to be used as plasticizers pursuant to this invention are polyhaloaromatic mono-sulfonamides containing in the molecule (a) from 7 to 30 carbon atoms (preferably 8 to 24), (b) from 2 to 12 halogen atoms (chlorine or more preferably bromine), (c) one nitrogen atom, (d) an aromatic group, bonded to the sulfur atom, in which at least two chlorine or more preferably at least two bromine atoms, or at least one chlorine atom and at least one bromine atom are directly bonded to the aromatic ring system, and (e) one or two organic (aliphatic, cycloaliphatic, or aromatic) groups bonded to the nitrogen atom. The bis-sulfonamides used as plasticizers pursuant to this invention are aromatic bis-sulfonamides containing at least two aromatic rings (preferably two or three) and from 14 to 30 carbon atoms (preferably 18 to 24) in the molecule. In addition to above compositions, mixtures of two or more mono-sulfonamides or two or more bis-sulfonamides may be used as plasticizers. If desired, mixtures of any one or more mono-sulfonamides with any one or more bis-sulfonamides may also be used as plasticizers.

The mono-sulfonamide to be used as plasticizers pursuant to this invention are polyhaloaromatic mono-sulfonamides containing in the molecule (a) from 7 to 30 carbon atoms (preferably 8 to 24), (b) from 2 to 12 halogen atoms (chlorine or more preferably bromine), (c) one nitrogen atom, (d) an aromatic group, bonded to the sulfur atom, in which at least two chlorine or more preferably at least two bromine atoms, or at least one chlorine atom and at least one bromine atom are directly boned to the aromatic ring system, and (e) one or two organic (aliphatic, cyclo-aliphatic, or aromatic) groups bonded to the nitrogen atom. One such organic group, when an aromatic group, optionally is substituted by one or more bromine or chlorine atoms. In a preferred embodiment these mono-sulfonamides contain from 3 to 8 and most preferably from 3 to 6 halogen atoms (chlorine, bromine or a mixture of both) bonded to the aromatic ring system

The composition may also comprise compounds giving UV light stability even though this is not necessary. These compounds may be chosen from oils, such as sunflower oil and soya oil e.g. Edenol E81 from Cognis.

The composition may also comprise a stabilizing agent in order to be more easily processed, such as barium and tin compounds such as butyltin-carboxylate chosen from. Mark or Meister BZ508 from Crompton.

Useful substances are described in C. F. Liable, Ballistic Materials and Penetration Mechanics, Chapters 5-7 (1980) such as single oxides e.g. aluminium oxide (Al₂ O₃), barium oxide (BaO), beryllium oxide (BeO), calcium oxide (CaO), cerium oxide (Ce₂O₃ and CeO₂), chromium oxide (Cr₂O₃), dysprosium oxide (Dy₂O₃), erbium oxide (Er₂O₃), europium oxide: (EuO, Eu₂O₃, and Eu₂O₄), (Eu₁₆O₂₁), gadolinium oxide (Gd₂O₃), hafnium oxide (HfO₂), holmium oxide (Ho₂O₃), lanthanum oxide (La₂O₃), lutetium oxide (Lu₂O₃), magnesium oxide (MgO), neodymium oxide (Nd₂O₃), niobium oxide: (NbO, Nb₂O₃, and NbO₂), (Nb₂O₅), plutonium oxide: (PuO, Pu₂O₃, and PuO₂), praseodymium oxide: (PrO₂, Pr₆O₁₁, and Pr₂O₃), promethium oxide (Pm₂O₃), samarium oxide (SmO and Sm₂O₃), scandium oxide (Sc₂O₃), silicon dioxide (SiO₂), strontium oxide (SrO), tantalum oxide (Ta₂O₅), terbium oxide (Tb₂O₃ and Tb₄O₇), thorium oxide (ThO₂), thulium oxide (Tm₂O₃), titanium oxide: (TiO, Ti₂O₃, Ti₃O₅ and TiO₂), uranium oxide (UO₂, U₃O₈ and UO₃), vanadium oxide (VO, V₂O₃, VO₂ and V₂O₅), ytterbium oxide (Yb₂O₃), yttrium oxide (Y₂O₃), and zirconium oxide (ZrO₂).

Useful ceramic materials also include boron carbide, zirconium carbide, beryllium carbide, aluminium carbide, boron carbide, silicon carbide, titanium nitride, boron nitride, titanium carbide, titanium diboride, iron carbide, iron nitride, barium titanate, aluminium nitride, titanium niobate, boron carbide, silicon boride, barium titanate, silicon nitride, calcium titanate, tantalum carbide, graphites, tungsten; the ceramic alloys which include cordierite/MAS, lead zirconate titanate/PLZT, alumina-titanium carbide, alumina-zirconia, zirconia-cordierite/ZrMAS; the fibre reinforced ceramics and ceramic alloys; glassy ceramics; as well as other useful materials.

Preferably slag from iron production is used for particles and powder. For the particles FeO, SiO₂, CaO, Al₂O₃, MgO, may be, especially iron sand (iron silicate) from Boliden, Sweden containing 45-50% FeO, 35-38% SiO₂ (bound), 2-46% CaO, 4-5% Al₂O₃, 1-1,5% MgO, water soluble chlorides<0.005% and free quarts<0.3% having a density of approximately 2000 kg/m³ may be used.

For the powder SiO₂, CaO, MgO, Al₂O₃, S, FeO and MnO may be used such as Merit from SSAB, Merox AB, 513 89 Oxelösund, Sweden, containing SiO₂ 34%, CaO 32%, MgO 18%, Al₂O₃ 12%, S 1.5%, FeO 0.50%, MnO 0.50% and having a true density of 2950 kg/m³ and a bulk density of 1100 kg/m³.

The paste may comprise 5-30 weight % powder of inorganic oxides, 20-75 weight % particles of inorganic oxides and 20-75% of polyvinyl chloride, polyurethanes or acrylates or a mixture thereof.

All percentages mentioned herein are by weight.

The paste may be applied by blade over air coating or blade over roller, preferably by a knife, e.g. i J-shaped knife over roller at any suitable angle, preferably at 10°. The conditions for applying the paste are dependent on the amount to be fixed on to the fabric. The amount applied is preferably 2000-3000 kg/m³, preferably 2200-2300 kg/m³.

The fabric may first be treated on one side with an adhesion promoter or a paste comprising the polyvinyl chloride, polyurethanes, acrylates or silicones possibly mixed with the adhesion promoter. Thereafter the fabric is dried.

The fabric is then treated with the paste comprising the particles of inorganic oxides and powder of inorganic oxides and the curable plastic material chosen from polyvinyl chloride, polyurethanes, acrylates or silicones. After treatment with the paste a heat treatment or curing of the paste is performed.

One or more layers of the fabric may be included in the article. The layers may be joined at the edges of the article and otherwise substantially be free from means for holding the layers of fabric together. Adjacent layers or articles may be fastened e.g. at the edges e.g. with glue or tape. There may also be some loose interlayer connections at relatively great spacings compared with the thickness of the articles. The layers may also be put into a bag of fabric. Preferably 1-5, especially 1-2 layers may be used such as 1 layer.

The protective article according to the invention is still very flexible and very usable when mainly threats with knives are at hand. It can be used together with any other type of protecting article in a protecting garment or waistcoat. Preferably the protective article is used as an outer stab resistant article together with an inner ballistic protective article and an intervening ice pick protective article. Therefore the invention also relates to a penetration resistant article comprising at least one inner ballistic resistant means and at least one intervening ice pick resistant means and one or more layers of a stab resistant fabric placed outwards, which fabric has a tensile strength larger than 50N/5 cm and is made from any synthetic, natural or glass fiber or derivatives or mixtures thereof and having been treated with a coating comprising 0.1-2 mm particles of inorganic oxides and powder of inorganic oxides having a true density of 1000-4000 kg/m³ and a curable material chosen from polyvinyl chloride, polyurethanes, acrylates or silicones, as a stab resistant means placed on the outside of the inner ballistic resistant layer and the intervening ice pick resistant article.

The ballistic protective means may be any known or future ballistic protective article, e.g. those described in U.S. Pat. Nos. 5,472,769, 6,133,169 and 5,677,029 and the inventors' own U.S. Pat. No. 5,903,920.

The ice pick resistant means may be any article protective against any piercing article such as ice picks, needles, cannulas etc, preferably together with the inventors' ice pick protecting article described in applicants US patent application concurrently filed the same day, which is hereby incorporated as reference.

When one layer produced according to example 1 is used as an outer layer with an article according to applicants' U.S. Pat. No. 5,903,920 as an inner ballistic protective means and 10 layers of an ice pick protective means according to applicants' patent application U.S. Pat. No. ______ filed the same day as an intervening piercing protective means, the composite article fulfils the NIJ standards for stab protection.

Another object of the invention is a method for protection of an article or a body against penetration articles wherein all or parts of said article or body is covered by a penetration resistant article comprising at least one inner ballistic resistant means and at least one intervening ice pick resistant means, wherein one or more layers of a stab resistant fabric is placed outwards of said at least one inner ballistic resistant means and said at least one intervening ice pick resistant means, which fabric has a tensile strength larger than 50N/5 cm and is made from any synthetic, natural or glass fiber or derivatives or mixtures thereof and having been treated with a coating comprising 0.1-2 mm particles of inorganic oxides and powder of inorganic oxides having a true density of 2000-3000 kg/m³ and a curable material chosen from polyvinyl chloride, polyurethanes, acrylates or silicones, as a stab resistant means outside an inner ballistic resistant layer and an intervening ice pick resistant article.

Still another objective of the invention is the use of a stab resistant article consisting essentially of one or more layers of a fabric with a tensile strength larger than 50N/5 cm made from any synthetic, natural or glass fiber or derivatives or mixtures thereof and having been treated with a coating comprising 0.1-2 mm particles of inorganic oxides and powder of inorganic oxides having a true density of 2000-3000 kg/m³ and a curable material chosen from polyvinyl chloride, polyurethanes, acrylates or silicones as a stab resistant means outside an inner ballistic resistant layer and an intervening ice pick resistant article.

The invention will now be described with reference to the accompanying figure:

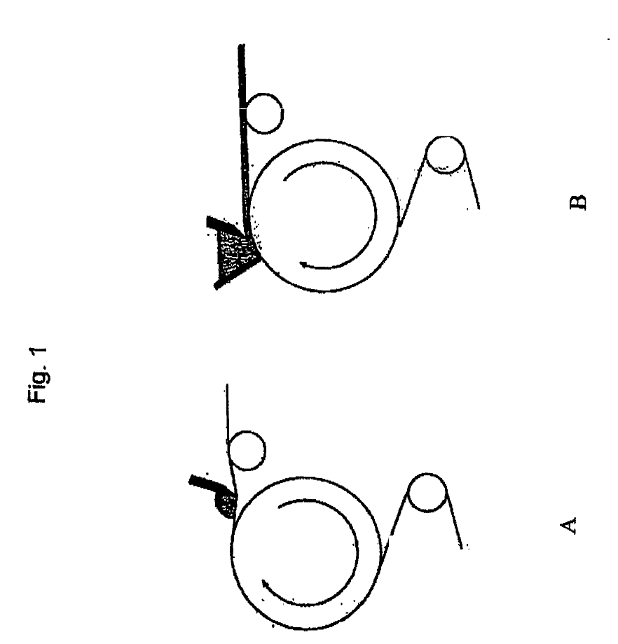

FIG. 1, which describes blade over air coating (fig A) and blade over roller coating (fig B).

All publications cited in this description are hereby incorporated by reference. The invention will now be described with the following non-limiting examples.

### EXAMPLE 1

A woven fabric with a length of 300 m and a width of 182 cm was produced from a Polyamid 6.6 yarn from Acordis type 444 HRST having a linear density of 470 dTex, with 72 filaments in warp and weft (Acordis Industrial Fibres GmbH & CO. KG Kasinostasse 19-21, D-42097 Wuppertal Germany). The construction was 1/1 plain and the finished fabric set 17 threads/cm in warp and 17 threads/cm in weft.

The fabric was washed with a wash solution comprising 50 ml/l NaOH, 40 ml/l Lavotan DSU (25-50% etoxylated oxoalcohol C13, 69011-36-5, Xi; R 36/38, 10-25% 2-metylpentan-2,4-diol, 107-41-5, Xi; 36/38, 2.5-5% etoxylated oxoalcohol C13, 69011-36-5, Xi, N; R 36/38-51/53, 2.5-5% alkane (C14/C16) sulphonic acid sodium salt 68439-57-6, Xi; R 36/38 from Nils Holmberg AB, Tamta Kil 31, SE-51393 Fristad, Sweden), 8 ml/I Heptol NWS (polyacrylic acid, sodium salt in water dispersion containing polyphosphate from Nils Holmberg AB as above). The washing was performed at 95° C. The fabric was then rinsed in water. The washing and rinsing are performed in a bath with a length of 17 m, comprising several rollers arranged so that 95 m is in the washing zone and 55 m is in the rinsing zone. The fabric is moved at a speed of 50 m/min.

Hereafter the fabric is dried at 130° C. at a speed of 44 m/min in an oven with a length of 24 m.

The fabric was coated with a base coat containing polyvinyl chloride and poly-isocyanate with a J-shaped knife with blade over air at an angle of 100. The fabric was then dried in an oven with three drying sections each 3 m at 160° C., 170° C. and 185° C. respectively at a rate of 10 m/min. 50 g/m² of the adhesion promoter composition was applied.

Thereafter the fabric was treated with a paste comprising 32 weight % PVC, 13 weight % merite and 55 weight % iron sand with a J-shaped knife over roller at an angle of 10°. The fabric was then dried in an oven with three drying sections each 3 m at 175° C., 185° C. and 190° C. respectively at a rate of 3 m/min. 2250 g/m² of the composition was applied.

1. A stab resistant article consisting essentially of one or more layers of a fabric with a tensile strength larger than 50N/5 cm having been treated with a coating comprising 0.1-2 mm particles of inorganic oxides and powder of inorganic oxides having a true density of 1000-4000 kg/m³ and a curable material curable to a flexible state chosen from polyvinyl chloride, polyurethanes, acrylates or silicones.

2. An article according to claim 1, wherein the fabric is made from any synthetic, natural or glass fiber or derivatives or mixtures thereof.

3. An article according to any of claims 1 or 2, wherein the fabric is a woven fabric made from a yarn comprising polyester, polyamide, polypropylene, polyethylene, cotton or derivatives or mixtures thereof.

4. An article according to any of claims 1 or 3, wherein a base coat containing an adhesion promoter is provided between the fabric and the coating.

5. An article according to any of claims 1 or 4, wherein the particles are chosen from FeO, SiO₂, CaO, Al₂O₃, and MgO.

6. An article according to claim 5, wherein the particles are chosen from the slag, iron sand.

7. An article according to any of claims 1-6, wherein the powder is chosen from, SiO₂, CaO, MgO, Al₂O₃, FeO and MnO.

8. An article according to claim 7, wherein the powder is chosen from the slag merit.

9. An article according to any of claims 1-8, wherein the composition comprises 5-30 weight % powder of inorganic oxides, 20-75 weight % particles of inorganic oxides and 20-75% of polyvinyl chloride, polyurethanes, acrylates or silicones or a mixture thereof.

10. An article according to any of claims 1-9, wherein at least two layers of the fabric are included in the article.

11. An article according to any of claims 1-10, wherein the article after being provided with said coating has been dried or cured.

12. A penetration resistant article comprising at least one inner ballistic resistant means and at least one intervening ice pick resistant means, wherein one or more layers of a stab resistant fabric is placed outwards, which fabric has a tensile strength larger than 50N/5 cm having been treated with a coating comprising 0.1-2 mm particles of inorganic oxides and powder of inorganic oxides having a true density of 1000-4000 kg/m³ and a curable material chosen from polyvinyl chloride, polyurethanes, acrylates or silicones as a stab resistant means placed on the outside of the ballistic resistant layer and the intervening ice pick resistant article.

13. A penetration resistant article according to claim 12, comprising an article according to any of claims 1-10 as a stab resistant means placed outwards of said at least one inner ballistic resistant means and said intervening ice pick resistant means.

14. A method for protection of an article or a body against penetration articles wherein all of or parts of said article or body is covered by a penetration resistant article comprising at least one inner ballistic resistant means and at least one intervening ice pick resistant means, wherein one or more layers of a stab resistant fabric is placed outwards of said at least one inner ballistic resistant means and said at least one intervening ice pick resistant means, which fabric has a tensile strength larger than 50N/5 cm having been treated with a coating comprising 0.1-2 mm particles of inorganic oxides and powder of inorganic oxides having a true density of 1000-4000 kg/m³ and a curable material chosen from polyvinyl chloride, polyurethanes, acrylates or silicones as a stab resistant means outside an inner ballistic resistant layer and an intervening ice pick resistant article.
